(19) United States
(12) Patent Application Publication
(10) Pub. No.: US 2013/0309579 A1
(43) Pub. Date: Nov. 21, 2013

(54) ELECTRODE CORE PLATE METHOD AND APPARATUS

(71) Applicants: Harry Shimp, Chagrin Falls, OH (US); Robert Bochman, Higganum, CT (US); Kenneth Mull, Woodbridge, CT (US)

(72) Inventors: Harry Shimp, Chagrin Falls, OH (US); Robert Bochman, Higganum, CT (US); Kenneth Mull, Woodbridge, CT (US)

(73) Assignee: DEXMET CORPORATION, Wallingford, CT (US)

(21) Appl. No.: 13/473,088

(22) Filed: May 16, 2012

(51) Int. Cl. H01M 4/04; H01M 4/80; H01M 4/64

(52) U.S. Cl. 429/242; 429/233; 216/13; 427/58

(57) ABSTRACT

The invention includes battery electrode core plates utilizing an expanded foil processed to reduce protrusions on the strands of the expanded foil. Expanded foils may be metal or metal-coated plastic. Reducing or eliminating protrusions on the expanded foil mitigate the risk of internal shorts due to protrusion cross-over or “hot spots.” Protrusion reduction may be achieved using chemical etching via various chemical or electrochemical processes that preferentially free or remove material from burrs and free chads, in addition to removing material from sharp edges of the expanded foil.

### BACKGROUND

The present application relates generally to battery electrodes utilizing expanded metal core plate material. In particular, the application subject matter reduces the occurrence of battery cell failure due to expanded metal protrusions shorting out the battery electrode.

In many battery electrodes, the anode or cathode active material may be in powder form. In order to manufacture a useable electrode, the active material may be pressed onto an electrode core plate. The core plate functions as the mechanical support for the electrode as well as acting as an electrically efficient current collector for the flow of electrons into or out of the battery cell. Various materials may be used for the core plate material in a battery electrode, many taking the form of an expanded metal foil.

The selection and design of an expanded metal foil or substrate, for use as an electrode core plate, may be optimized for electrical conductivity, chemical non-reactivity, and mechanical capability (for holding the active material powder in place).

The “skeleton” configuration of expanded metal substrates offers several advantages, such as increased surface area and thickness. However, the manufacturing process of expanding metal foils may result in protrusions, such as small burrs and chads on the foil. Most of these protrusions are small enough to be ignored, but some may be long enough to extend through the active material of the battery electrode and short the electrode out, causing battery cell failure. In severe cases, the short may result in overheating intense enough to cause fires.

A reduction in the number and severity of these protrusions may greatly reduce the degree of battery cell failures due to internal shorts from protrusion cross-over.

### SUMMARY

According to one aspect of the present invention, a method of making an electrode core plate for a battery, including: providing an electrically conductive plate; forming the plate into an expanded substrate; and reducing protrusions on the expanded substrate.

According to a further aspect of the present invention, a method of making an electrode for a battery, including: producing an electrode core plate, including: providing an electrically conductive plate; forming the plate into an expanded substrate; and reducing protrusions on the expanded substrate; and applying a coating material to the electrode core plate, wherein the coating material allows the electrode to act as an anode or cathode in the battery.

According to a further aspect of the present invention, an electrode core plate for a battery, including an expanded substrate, wherein the expanded substrate has been subjected to a protrusion reducing operation.

According to a further aspect of the present invention, an electrode for a battery, including: an expanded substrate, wherein the expanded substrate has been subjected to a protrusion reducing operation; and a coating material, wherein the coating material allows the electrode to act as an anode or cathode in the battery.

### BRIEF DESCRIPTION OF THE DRAWINGS

FIG. 1 is a cross section drawing of layers of an exemplary battery cell with two electrodes;

FIG. 2 is a drawing of an exemplary expanded foil;

FIG. 3 is a cross section drawing of a strand of an exemplary expanded foil, taken along line 3-3 in FIG. 2;

FIG. 4 is a cross section drawing of an exemplary battery cell with expanded foil electrode core plates;

FIG. 5 is a cross section drawing of a strand of an exemplary expanded foil in which the number or severity of protrusions has been reduced;

FIG. 6 is a cross section drawing of an exemplary battery cell with the exemplary expanded foil of FIG. 5;

FIG. 7 is a block diagram of a method of manufacturing an exemplary processed expanded foil; and

FIG. 8 is an embodiment of a system to manufacture an exemplary processed expanded foil.

### DESCRIPTION

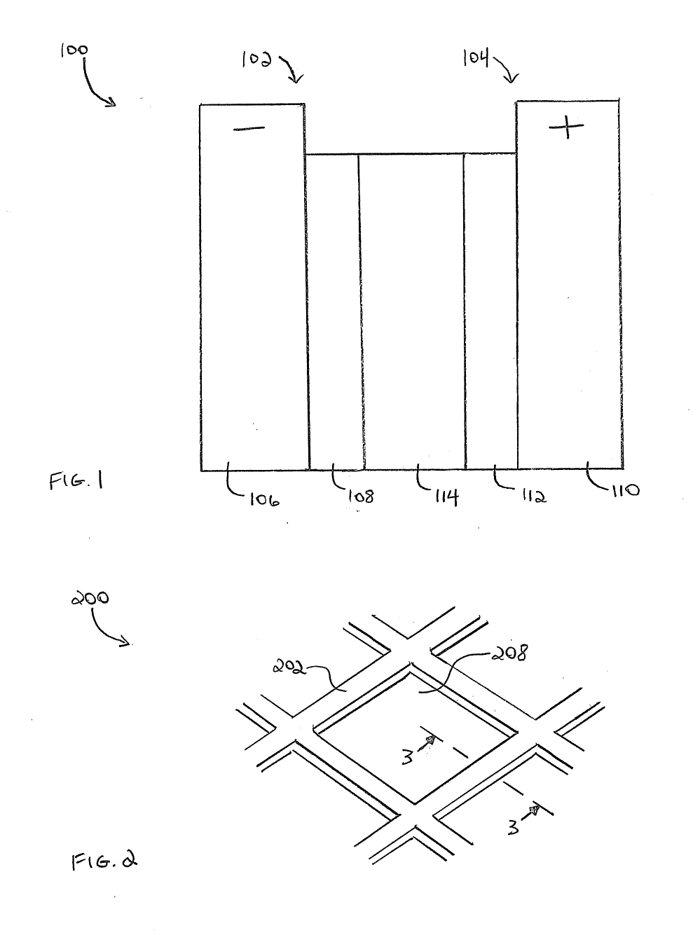

The electrode structure of an exemplary battery cell 100 is shown in FIG. 1. The battery cell 100 is shown with two electrodes, an anode 102 and a cathode 104. The anode 102 is the negative electrode, which gives up electrons during discharge. The cathode 104 is the positive electrode, which accepts electrons during discharge. The anode 102 includes an anode core plate 106 and anode active material 108. The cathode includes a cathode core plate 110 and cathode active material 112. The battery cell 100 also includes an electrolyte 114, which provides the medium for the transfer of ions between the anode 102 and cathode 104. The electrolyte 114 is a nonconductor to prevent internal discharge of the battery cell 100.

The electrode core plates 106, 110 may be produced from a metal or metal-coated plastic. For example, the core plates 106, 110 may be in the form of a solid foil, an expanded foil, a woven wire screen, or the like. Exemplary metals that may be used for the anode core plate 106 and the cathode core plate 110 include nickel and stainless steel, among others.

FIG. 2 is a drawing of an exemplary expanded metal or metal-coated plastic foil 200 that can be used as the electrode core plates 106, 110. The expanded foil 200 may have a lattice-like grid of strands 202 separated by openings 208. For example, as depicted in FIG. 2, the strands 202 may be configured with diamond-shaped openings 208. However, the expanded metal foil 200 may be configured with metal strands 202 and openings 208 of any shape, size, and thickness suitable for a particular application.

The expanded foil 200 may be produced, for example, by the action of two opposing dies. For example, a method of slit and stretch may be used. In this manner, precision dies can pierce and extend the foil material in the direction of the feed, for example, in one or more operations. The material can then be directed through a set of rollers to adjust the material to a final thickness for the expanded foil 200. The shape, form, and number of openings are dictated by the particular die set used and may be modified or changed to suit a particular application and material selection.

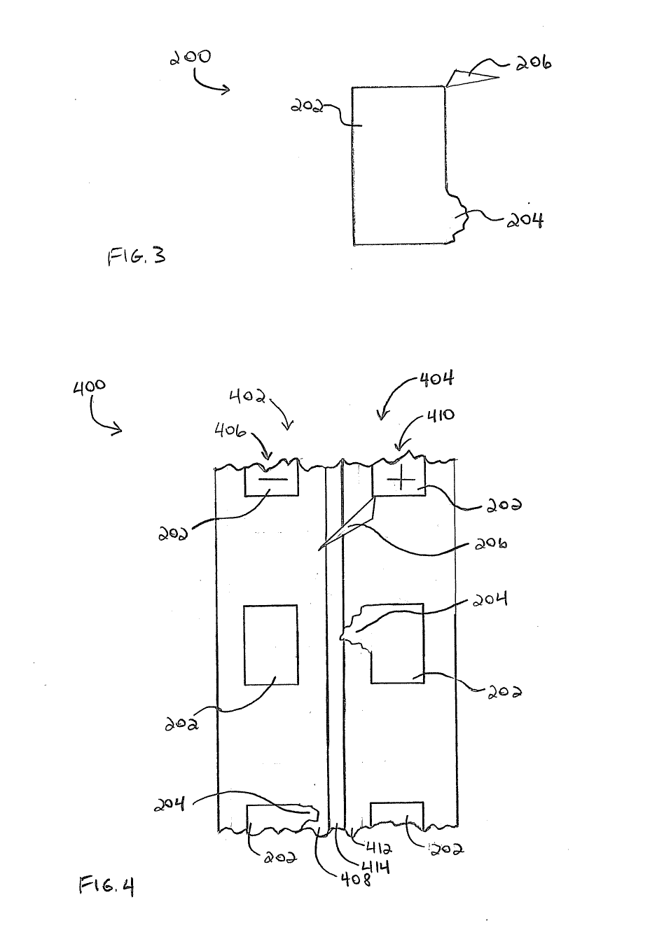

Due to the metal forming operations, the resultant expanded foil 200 may have various protrusions, such as burrs or chads along the strands 202. In general, such protrusions may be accepted by the user of the finished part. These characteristics can vary in many ways, such as shape, size, number, location, and severity. FIG. 3 is a cross section drawing of a strand 202 in an exemplary expanded foil 200, taken along line 3-3 in FIG. 2, showing some of these exemplary protrusions. For example, a burr 204 is shown extending from the surface of the metal strand 202 and a chad 206 is shown hanging from the edge of the metal strand 202. For illustration purposes, the burr 204 and chad 206 are drawn relatively large, but they may also be very small. However, relatively small burrs 204 and chads 206 may not pose a risk of internally shorting the battery cell 100. Although the exemplary protrusions shown in FIG. 3 are along the sides of the metal strands 202, the burrs 204 and chads 206 may occur anywhere throughout the expanded foil 200, including on the relatively flat sides of the strands 202 and in the areas where two or more strands 202 intersect, forming corners in the exemplary grid.

FIG. 4 shows a cross section drawing of another exemplary battery cell 400. In this embodiment, the battery cell 400 may have electrode core plates utilizing the expanded foil 200 with strands 202 from FIG. 3. An anode 402 includes an expanded core plate 406 and active material 408. A cathode 404 includes an expanded core plate 410 and active material 412. The battery cell 400 also includes an electrolyte 414 separating the electrodes 402, 404.

The strands 202 of the expanded core plates 406, 410 are shown exhibiting exemplary protrusions, such as burrs 204 and chad 206. It should be evident that relatively large burrs 204, chad 206, and similar protrusions along the strands 202 located near the electrolyte 414 may extend near, into and/or through the active material 408, 412 and electrolyte 414, potentially causing short-circuit pathways. For example, as shown in FIG. 4, a chad 206 may extend from the metal strand 202 of the cathode expanded core plate 410, through the cathode active material 412 and the electrolyte 414 zone, making contact with the anode active material 408. This is an example of a severe short-circuit. In another example, also shown in FIG. 4, a burr 204 may extend from the strand 202 of the cathode expanded core plate 410 into the electrolyte 414 zone. This is an example of a short-circuit. In either of these two situations, and any other where a protrusion of the strand 202 of the expanded core plates 406, 410 makes contact with the electrolyte 414, active material 408, 412 of another electrode 402, 404, or core plate 406, 410 of another electrode 402, 404 (referred to as protrusion cross-over), the battery cell 400 may short out, resulting in battery cell 400 failure. A short results in a completed circuit between the electrodes 402, 404 of the battery cell 400, discharging the electrical potential rapidly, since there may be very little electrical resistance in the shorted path between the anode 402 and cathode 404. In some situations, the current flow through the short may be extreme enough to create excessive heat and/or result in fire.

FIG. 4 also shows another exemplary burr 204 extending from the strand 202 of the anode expanded core plate 406 close to the electrolyte 414 zone. This is an example of a “hot spot.” In this situation, the burr 204 does not necessarily create an immediate short-circuit, but may create reduced resistance between the electrodes 402, 404, which may result in reduced battery cell 400 performance and/or ultimately lead to a short-circuit at a later time.

Protrusions that initially do not short out the battery cell 400 remain a potential latent risk and may eventually result in battery cell 400 failure. The battery cell 400 may be exposed to mechanical or electrical stresses, subjected to impacts or vibration, or undergo changes in its environment during its lifetime that may allow a protrusion to short out the battery cell 400 after operating normally for some period of time. A reduction in the number or severity of these protrusions may greatly reduce the occurrence of initial and latent battery cell 400 failure due to internal shorts.

Additionally, battery designs are becoming thinner and thinner for smaller hand-held devices (such as, for example, mobile devices, especially, for example, an iPod Nano). The elimination of burrs and chads becomes more important for thinner battery designs. Burrs 204, chads 206, and similar protrusions on the strand 202 of the expanded foil 200 may be reduced and their effects neutralized by post expansion processing. Such processing may reduce either the number, or severity, or both, of the protrusions, resulting in smoother and duller surfaces. Chemical and electro-chemical etching are exemplary methods of post expansion processing of the expanded foil 200. For example, the expanded foil 200 may be acid etched to reduce the number and severity of protrusions, such as burrs and chads, resulting in smoother and duller surfaces. Various types of chemical solutions may be used to etch the expanded foil, including various acid-based solutions. In a particular exemplary application, a chlorine-based solution, such as ferric chloride (FeCl₃), may be used to etch a Copper expanded foil. Other potential post expansion processing methods include mechanical micro-deburring.

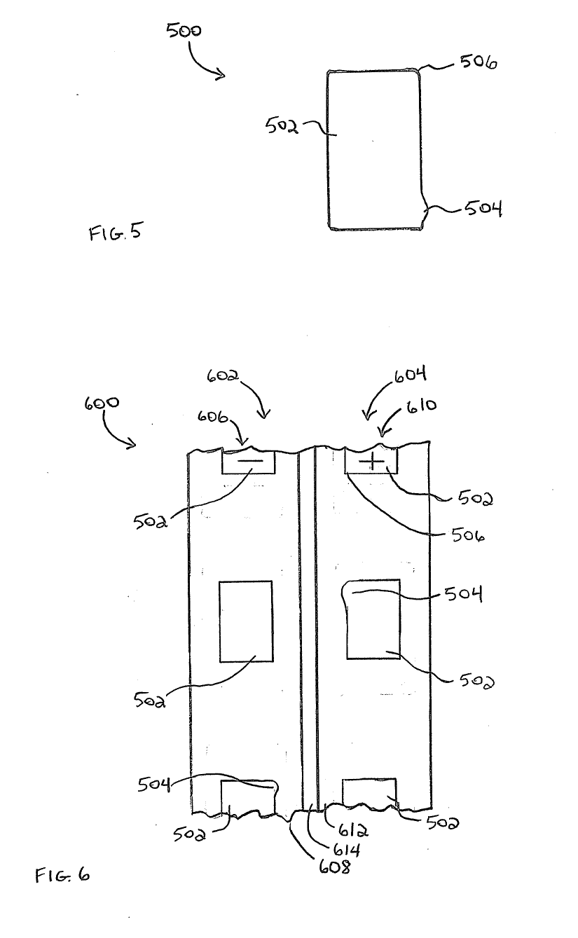

FIG. 5 shows a strand 502 of a processed expanded foil 500. For example, the processed strand 502 in FIG. 5, when compared to the unprocessed strand 202 of FIG. 3, shows the effects of post expansion processing on the expanded foil 500. In particular, the burr 204 is processed into a rounded hump 504 and the chad 206 is removed and replaced with a dull edge 506.

FIG. 6 shows a cross section drawing of another exemplary battery cell 600. In this embodiment, the battery cell 600 may have electrode core plates utilizing the expanded foil 500 with strands 502 from FIG. 5. An anode 602 includes a processed expanded core plate 606 and active material 608. A cathode 604 includes a processed expanded core plate 610 and active material 612. The battery cell 600 also includes an electrolyte 614 separating the electrodes 602, 604.

The processed strands 502 in FIG. 6, when compared to the unprocessed strands 202 of FIG. 4, show the effects of post expansion processing on the electrode core plates 606, 610 of the battery cell 600: a reduction in the number and severity of the protrusions, thus mitigating the risk of internal shorts due to protrusion cross-over or hot spots.

The strands 502 of the processed expanded core plates 606, 610 are shown after processing exemplary protrusions, such as burrs 204 and chad 206, from FIGS. 3 and 4. The burrs 204 are now rounded humps 504 and the chad 206 is removed replaced with dull edge 506. In particular, as shown in FIG. 6, the dull edge 506 does not extend from the metal strand 502 of the cathode processed expanded core plate 610, stays within the cathode active material 612 area, and does not penetrate the electrolyte 614 zone, avoiding making contact with the anode active material 608. Similarly, also shown in FIG. 6, the rounded humps 504 do not extend from the metal strand 502 of the electrode processed expanded core plates 606, 610, stay within the electrode active material 608, 612 areas, and do not penetrate or come near the electrolyte 614 zone.

In both of these examples, post expansion processing of the expanded metal foil 200 reduced the number and severity of the protrusions, eliminated the potential conductive contact between the electrodes 602, 604, and thus mitigated the risk of internal shorts due to protrusion cross-over or hot spots.

Chemical etching may be done using a variety of chemical or electrochemical processes that preferentially free or remove material from burrs 204 and free chads 206, in addition to removing material from sharp edges of the expanded foil 200. These processes result in a reduction in the number and severity of protrusions on the expanded foil 200 and, consequently, reduce the likelihood of protrusion cross-over or hot spots that can cause internal shorts and failure in the battery cell 600.

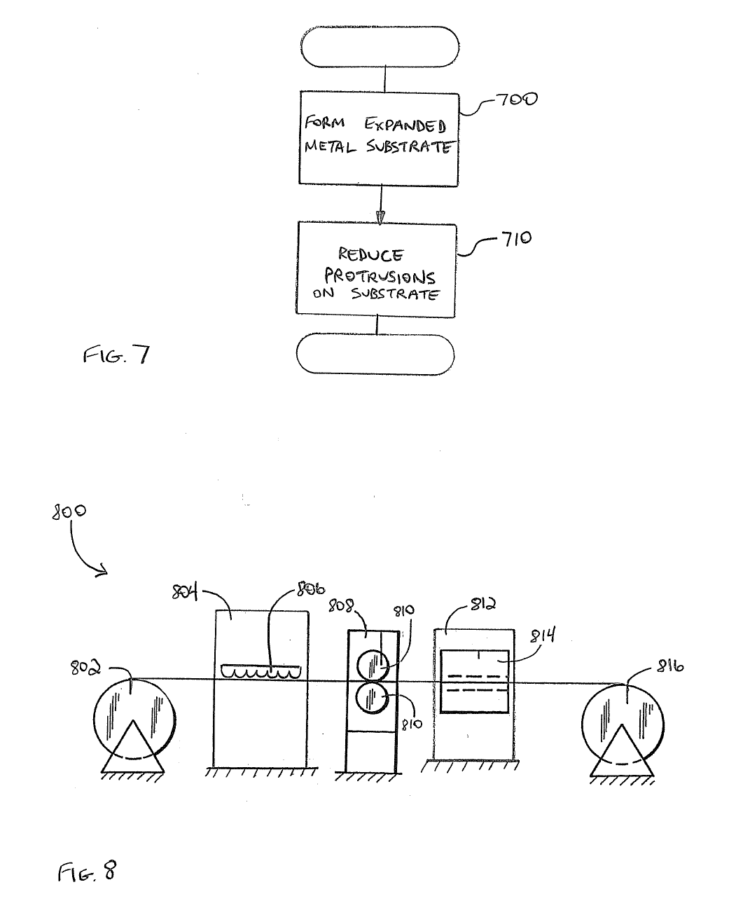

The block diagram in FIG. 7 represents one embodiment of how to make processed expanded foil 500 for use as the electrode core plates 606, 610 of FIG. 6. Only two steps are illustrated, but any number of functions, operations, processes, steps, or the like may be added to the flow for purposes of enhanced utility, performance, measurement, troubleshooting, and the like. It is understood that all such variations are within the scope of the present invention.

The flow of manufacturing an exemplary electrode's processed expanded metal core plates 606, 610 may begin in block 700 where a metal plate is formed into an expanded metal substrate or foil 200. The metal plate may be any suitable metal appropriate for use in any particular battery cell application. The dimensions of the expanded metal substrate, such as the metal substrate thickness, strand 202 width, opening 208 length, and opening 208 width, may be any dimensions suitable for a particular application. Design considerations for the expanded foil 200 material and dimensions may include the mechanical support necessary for the electrode, electrical conductivity, chemical non-reactivity, and mechanical capability (for holding the active material powder in place).

After forming the expanded metal substrate or foil 200 in block 700, the flow may proceed to block 710, where protrusions on the expanded foil 200 are reduced. Any suitable process for reducing the protrusions may be used, such as chemical etching or mechanical micro-deburring, as described above. Reducing the protrusions on the expanded foil 200 results in the processed expanded foil 500, which may be used for the electrode core plates 606, 610. A metal-coated plastic may be manufactured in a similar manner, including a coating process.

The illustration in FIG. 8 represents one embodiment of a system 800 that may be used to manufacture the processed expanded foil 500 of FIG. 5, for use as the electrode core plates 606, 610. Although FIG. 8 shows a specific order of devices and executing processes, the order of the devices and process execution may be changed relative to the order shown. Also, two or more devices or processes shown in succession may be executed concurrently or with partial concurrence. Certain devices and processes also may be omitted. In addition, any number of devices, equipment, processes, operations, steps, or the like may be added for purposes of enhanced utility, performance, measurement, troubleshooting, and the like. For convenience, the exemplary devices are shown as part of a continuous production process, but the devices may be arranged and the processes may be performed independently without a connected flow. It is understood that all such variations are within the scope of the present invention.

FIG. 8 shows the exemplary system 800 as an exemplary continuous feed process for manufacturing processed expanded foil 500. A metal plate reel 802 may hold and feed a strip of the metal plate material. The strip of the metal plate material may be unwound and fed through a slit and stretch device 804. In one embodiment, the slit and stretch device 804 may include a precision die 806 that can slit and stretch the metal plate material in one operation. However, in other embodiments, slit and stretch or similar operations may be performed by separate devices in separate operations.

The metal material may then be directed through a roller device 808 with a set of rollers 810 to adjust the metal material to a final thickness for the expanded metal foil 200. The rollers 810 may exert a high pressure on each side of the metal material sufficient to reduce the thickness of the expanded foil 200 to a dimension appropriate for a particular application. In some cases, the thickness of the metal material exiting the slit and stretch device 804 may be suitable for a particular application, eliminating the need for the roller device 808. As mentioned above, the shape, form, number of openings, and thickness of the metal material are dictated by the particular tool used and may be modified or changed to suit any particular application.

The expanded foil 200 may then be fed through a protrusion reduction device 812. The protrusion reduction device 812 may, for example, include one or more chemical etching stations 814. Chemical etching stations 814 may be used independently or in combination, including in combination with other protrusion reduction stations 814. Each station 814 may allow for variations in operational parameters, such as, for example, time and intensity variables. For example, the amount of time and intensity necessary to reduce protrusions on the expanded foil 200 at any of the stations 814 may vary depending on the particular application and what level of reduction is necessary. Also, operational parameters at the stations 814 may be adjusted based on variation in the number and severity of the protrusions, which may vary with, for example, tool wear of the slit and stretch device 804, metal material property variation, and other processing variables. The output of the protrusion reduction device 812 is processed expanded foil 500 for use as the electrode core plates 606, 610 of FIG. 6.

In some applications, the processed expanded foil 500 may then be fed onto a processed expanded foil reel 816. In other applications, the processed expanded foil 500 may be cut by a cutting apparatus (not shown) into sheets having any desired shape and size. The sheets may be the appropriate size for use as electrode core plates 606, 610 or may be subsequently cut to the appropriate size.

Once the processed expanded foil 500 is manufactured, various subsequent operations, such as cutting, forming, and coating may be necessary to manufacture the electrode 602, 604 and battery cell 600.

The processed expanded foil 500 may be used in a variety of battery cell and fuel cell applications. Battery cell applications include both primary (non-rechargeable) and secondary (rechargeable) technologies.

Although embodiments of the invention have been shown and described, it is understood that equivalents and modifications will occur to others in the art upon the reading and understanding of the specification. The present invention includes all such equivalents and modifications.

We claim:

1. A method of making an electrode core plate for a battery, comprising the steps of:
providing an electrically conductive plate;
forming the plate into an expanded substrate; and
reducing protrusions on the expanded substrate.

2. The method of claim 1, wherein the electrically conductive plate comprises a metal.

3. The method of claim 2, wherein the electrically conductive plate comprises a metal-coated plastic.

4. The method of claim 1, wherein the step of reducing protrusions on the expanded substrate comprises a chemical or an electrochemical process.

5. A method of making an electrode for a battery, comprising the steps of:
producing an electrode core plate, comprising the steps of:
providing an electrically conductive plate;
forming the plate into an expanded substrate; and
reducing protrusions on the expanded substrate; and
applying a coating material to the electrode core plate, wherein the coating material allows the electrode to act as an anode or cathode in the battery.

6. The method of claim 5, wherein the step of reducing protrusions on the substrate comprises a mechanical process.

7. The method of claim 5, wherein the electrically conductive plate comprises a metal.

8. The method of claim 7, wherein the electrically conductive plate comprises a metal-coated plastic.

9. An electrode core plate for a battery, comprising an expanded substrate, wherein the expanded substrate has been subjected to a protrusion reducing operation.

10. The electrode core plate of claim 9, wherein the electrically conductive plate comprises a metal.

11. The electrode core plate of claim 10, wherein the electrically conductive plate comprises a metal-coated plastic

12. The electrode core plate of claim 9, wherein the protrusion reducing operation comprises a chemical or electrochemical process.

13. An electrode for a battery, comprising:
an expanded substrate, wherein the expanded substrate has been subjected to a protrusion reducing operation; and
a coating material, wherein the coating material allows the electrode to act as an anode or cathode in the battery.

14. The electrode of claim 13, wherein the expanded substrate comprises a metal.

15. The electrode of claim 14, wherein the expanded substrate comprises a metal-coated plastic

16. The electrode core plate of claim 13, wherein the protrusion reducing operation comprises a chemical or electrochemical process.
